(19) United States
(12) Patent Application Publication
(10) Pub. No.: US 2008/0196325 A1
(43) Pub. Date: Aug. 21, 2008

(54) Cavity Closer Apparatus

(75) Inventors: Malcolm Charles Howorth, Blandford Forum (GB); Graham Cedric Howorth, Cheddar (GB); Peter Brian Dunford, Bournemouth (GB)

Correspondence Address: MILES & STOCKBRIDGE PC, 1751 PINNACLE DRIVE, SUITE 500, MCLEAN, VA, 22102-3833, US

(73) Assignee: ICF Technologies Limited, Blandford Forum, Dorset (GB)

(21) Appl. No.: 12/034,592

(22) Filed: Feb. 20, 2008

(30) Foreign Application Priority Data
Feb. 20, 2007 (GB) 0703270.9

(51) Int. Cl. E06B 1/60; E04C 5/12; E04G 17/00

(52) U.S. Cl. 52/127.2; 249/219.1; 52/745.21

(57) ABSTRACT

The invention provides cavity closer apparatus in strip form and suitable for use with ICF walls, the apparatus comprising a body member including a central portion for bridging the cavity between inner and outer wall leaves and respective front and rear projections for engaging the exposed ends of the leaves, in use, in which the body member incorporates means for lockable engagement of fixing cleats for a window or door frame. The central portion of the body member may include a housing defining one or more voids containing insulation material and the fixing cleats may comprise clips formed from a flat strip of springy or resilient material adapted at the forward end portion for attachment to a door or window frame element and at the rearward end portion for lockable engagement with the body member, behind the frame element. The apparatus may also include a spacer member in strip form, the body and spacer members including means for mutual engagement at a desired position of the spacer member relative to the depth of the body member, the spacer member including means for lockable engagement of fixing cleats for the window or door frame.

This invention relates to cavity closer apparatus especially, but not necessarily, for use with insulated concrete form (ICF) walls.

ICF walls are increasingly being used not only for construction of domestic buildings but also for larger commercial structures and are particularly beneficial in environmental terms in providing high levels of heat insulation; walls can also be erected much faster than with traditional construction methods. ICF walls comprise inner and outer leaves formed from expanded polystyrene blocks held in place by webs moulded into the polystyrene to define a cavity which, after addition of appropriate steel reinforcement, if required, is filled with ready-mixed concrete. The exterior surface of the polystyrene blocks can be coated with brick slips or other cladding for decorative purposes. The interior surface of the inner leaf can be covered with plasterboard and decorated, in the conventional manner.

Before pouring the concrete, it is necessary to close the exposed cavity around window and door openings and, for this purpose, GB 2397588 describes a cavity closer including an adjustable window/door frame fixing system which accommodates frames of different sizes and incorporates a raised housing on which the window or door frame engages and behind which are integrally-formed recesses to receive female carriages which selectively, for adjustment purposes to accommodate different depths of frame, can receive male projections formed on the underside of a locking member which includes a resilient seal to abut the inner surface of the frame. It has been found in practice, however, that such arrangements have certain disadvantages. For example, the raised housing effectively creates a void under the external sill; additionally, the locking member is adjustable only incrementally, according to the spacing of the male/female interlockable parts, the resilience of the seal being relied on to fill the remaining small gap between the locking member and the frame.

It is an object of the present invention to provide a cavity closer which overcomes the disadvantages of currently-available apparatus.

In one aspect, the present invention provides cavity closer apparatus in strip form and suitable for use with ICF walls, the apparatus comprising a body member including a central portion for bridging the cavity between inner and outer wall leaves and respective front and rear projections for engaging the exposed ends of the leaves, in use, in which the body member incorporates means for lockable engagement of fixing cleats for a window or door frame.

Preferably, the central portion of the body member includes a housing defining one or more voids containing insulation material, the respective front and rear walls of the housing being sized to fit within the cavity of the wall to prevent cold bridging. Conveniently, the underside of the central portion, or the bottom wall of the insulation housing, includes integral formations which, in use, become embedded in the wet concrete as it is being poured and which, after the concrete has cured, lock the body member permanently in place against the edge of the door or window opening.

The fixing cleats preferably comprise clips formed from a flat strip of springy or resilient material, preferably metal, adapted at one end portion (the forward end) for attachment to a door or window frame element and at the other (rearward) end portion for lockable engagement with the body member, behind the frame element, whereby the frame can be inserted from the interior of the building and locked in position from the inside. Preferably, the fixing cleats are snap-engageable in longitudinal channels formed in the body member. In a more preferred arrangement, the body member includes two or more longitudinal channels, so that a selected channel may be used for engagement of the fixing cleat according to whether the frame is required to be positioned relatively forwardly or relatively rearwardly in relation to the wall opening. By way of example, for lockable engagement by snap action, the rear or tail end of the fixing cleat may have a U formation and the longitudinal channel may have a projection overhanging its rear wall, the limbs of the U formation being resiliently inwardly compressible on insertion within the channel and the distal or free end of the U formation lockably engaging under the overhang. The fixing cleat preferably has an intermediate portion, between the end portions, which passes beneath the rear wall of the frame, thereby locking the frame in its desired position when the cleat is engaged with the body member.

Where the lower element of the frame is formed as or includes a sill, either a window sill or a door sill, the element is attached direct to the body member of the cavity closer apparatus in the manner described. However, where the wall cladding, for example, brick slips, is intended to extend around the reveal of the window or door aperture, to simulate a wall constructed from traditional bricks, it is necessary for the head and side elements of the frame to be spaced from the top and sides or jambs of the opening by an amount equivalent to the depth of the brick slips. Accordingly, the apparatus according to the invention also includes a spacer member in strip form, the body and spacer members including means for mutual engagement at a desired position relative to the depth of the body member, the spacer member including means for lockable engagement of fixing cleats for the window or door frame. Thus, the spacer member, which preferably is also formed as a housing defining a void containing insulation material, may be formed with a longitudinal channel in like manner as that formed in the body member, for lockable engagement of fixing cleats for the frame in the same way as already described for direct attachment of the frame to the body member. For mutual engagement purposes, the body and spacer members may be formed with interlockable or interengageable projections/recesses which, for example, may be formed as cavities in one member and projections formed on the other member for engagement in the cavities, preferably with a force or interference fit, or as a longitudinal groove formed in one member for receipt of a corresponding longitudinal ridge or projection formed on the other member, preferably having a dovetail cross section for retention purposes. Preferably, the mutual interengagement means are provided for selective positioning of the spacer member relative to the body member, again according to the desired position of a frame relative to the depth of the wall.

Apparatus according to the invention preferably further includes an elongate stop member, attachable to the spacer member, to provide a forward abutment for the frame when placed in position from the interior of the building. The stop member may comprise an L member in cross section and the front upper part of the spacer member may be formed with a recess to accommodate the base part of the L; the stop member and the spacer member may be formed with interlockable projections similar to those of the body and spacer members.

Using apparatus according to the invention, the fixing cleats may be attached to the window or door frame at any position to provide a snug location of the frame, following engagement of the cleat to the body member or spacer member, against the stop member, irrespective of the depth of the frame elements, requiring to be sealed only by an external mastic sealing strip.

Apparatus according to the invention can be formed from re-ground PVCu plastics material, insulation material within the housing comprising a phenolic foam material. The body member, spacer member and stop member may be supplied in strip form to be cut, mitred, folded and glued on site according to the dimensions dictated by the window and door dimensions.

Embodiments of the invention will now be described by way of example with reference to the accompanying drawings, of which:

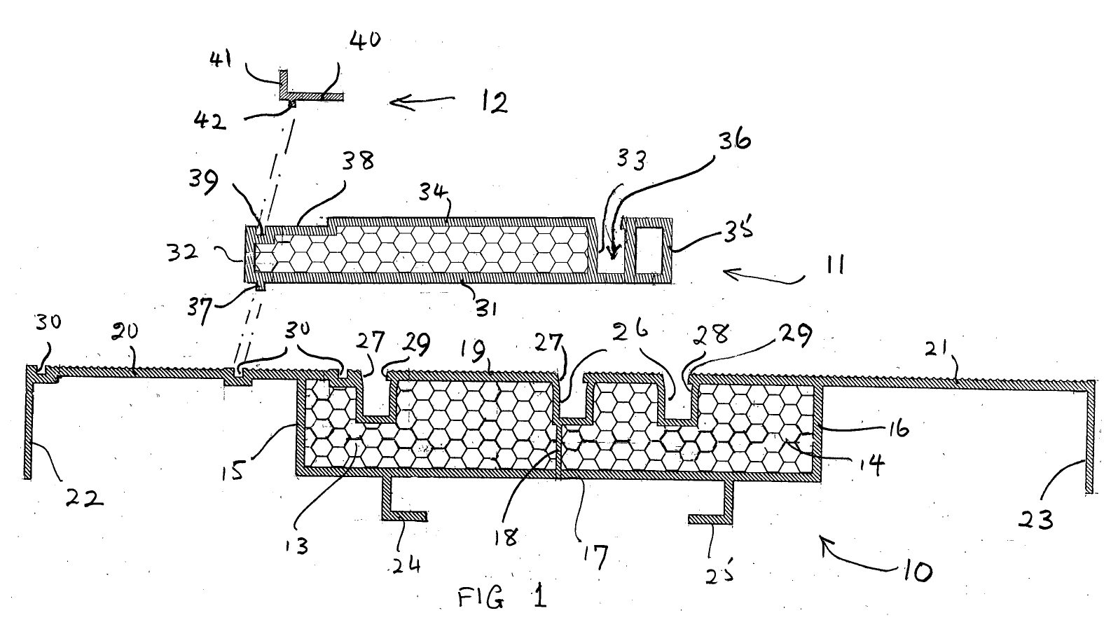

FIG. 1 is an exploded cross-sectional view of a body member, a spacer member and a window stop member constructed in accordance with the present invention;

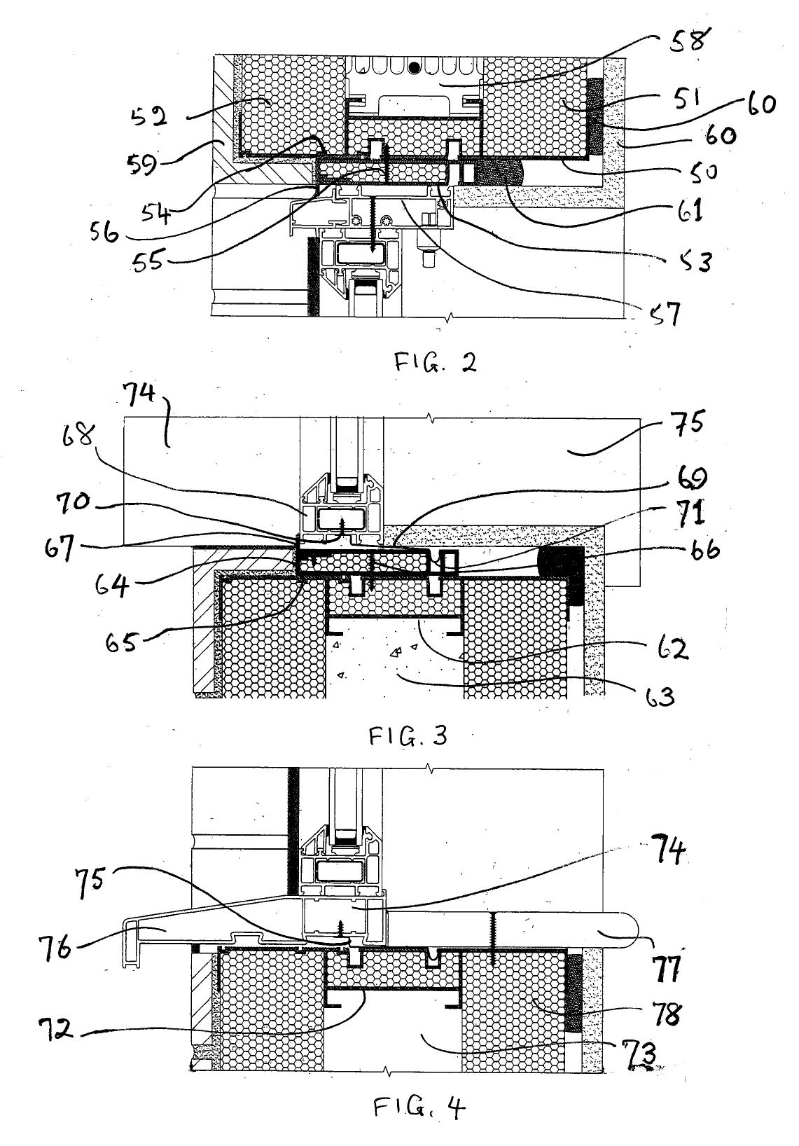

FIG. 2 is a vertical section showing apparatus according to the invention when installed at the head of a window aperture, also showing part of the window frame;

FIG. 3 is a horizontal section of apparatus according to the invention when installed at the jamb of a window aperture;

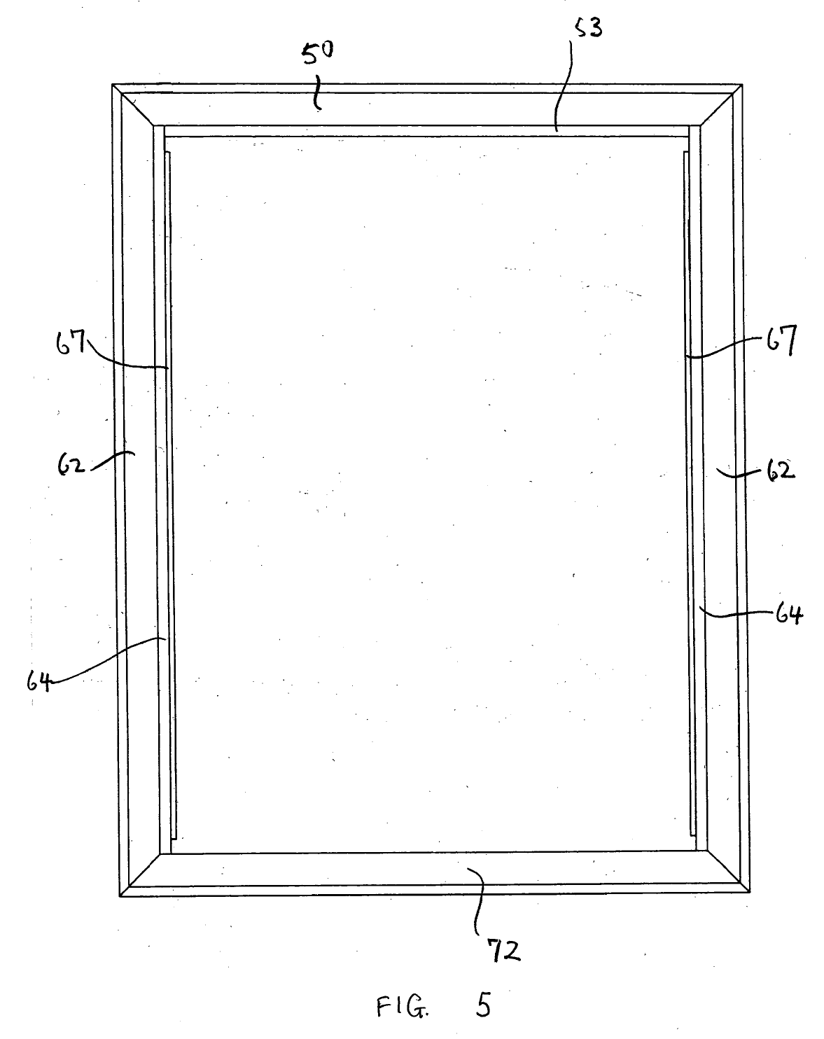

FIG. 4 is a vertical section of apparatus according to the invention when installed at the bottom of a window aperture, also showing internal and external window sills; and

FIG. 5 is an external frontal elevation of apparatus according to the invention when assembled for installation in a window aperture.

With reference firstly to FIG. 1, the apparatus as shown consists essentially of a base or body member 10, a spacer member 11 and a stop member 12. The base member 10 has a central portion comprising longitudinal housings 13, 14 defined by respective outer walls 15, 16, a lower wall 17 and an internal wall 18 separating the housings. The upper wall 19 of the housings has respective forward and rearward extensions 20, 21 each terminating in a depending flange 22, 23. The upper surface of the wall 19 and the extensions 20, 21 is shaped to provide a key for external finishes such as render, or to provide a key for adhesive when brick slips are being used. The housings 13, 14 contain a rigid insulation material. The lower wall 17 is provided with external projections 24, for keying with concrete when filled into the cavity between the inner and outer leaves of the wall, the central portion of the body member being sized (between the outer end walls 15, 16) to be accommodated within the cavity and the front and rear extensions being sized for engagement over the ends of the insulation blocks forming the inner and outer leaves. The upper wall of the central section of the body member includes longitudinal channels 26 defined by vertical walls, the upper portions 27 of the front walls being angled slightly away from the vertical and the upper portions 28 of the rear walls also being angled away from the vertical but in the other direction from the front walls, a chamfered lip 29 of the upper wall 19 forming a slight overhang to the rear wall. The upper wall 19 and the front extension 20 are also formed with longitudinal dovetail-shaped grooves 30.

The spacer member 11 has a base 31, front wall 32, a rear wall 33 and a top wall 34 defining a housing also containing a rigid insulation material. A rear extension 35 defines, together with rear wall 33, a channel 36 shaped and dimensioned essentially the same as the channels formed in the body member 10. The base 31 is formed with a depending longitudinal ridge 37 with a dovetail shape to engage in a selected groove 30 formed in the body member 10. The front portion of the top 34 is formed as a recess or rebate 38 itself formed with a dovetail groove 39.

The stop member 12 has an L cross-sectional shape with a base 40 and an upstanding front wall 41. A dovetail ridge projection 42 is formed below the base 40 for engagement in groove 39 formed in the spacer member 11.

With reference to FIGS. 2, 3 and 4, FIG. 2 shows a body member 50, similar to that shown in FIG. 1 but with only a single insulation-filed void formed by the central housing, attached at the head of a window aperture to inner 51 and outer 52 leaves of an ICF wall. A spacer member 53 is attached to the body member 50 by force-fitting engagement of dovetail groove/projection 54, and by screw 55. The spacer member has a stop member 56 attached thereto. The head element 57 of the window frame engages the spacer member 53; a fresh air vent 58 is provided in the cavity of the wall. As can be seen, the outer wall is faces with brick slips 59 and the inner wall is formed of plasterboard 60 bedded on mortar 61.

In FIG. 3, which is a horizontal section looking vertically downwards, the body portion 62 of the apparatus is locked to the inner and outer leaves of the ICF wall by concrete 63 and a spacer member 64 is attached thereto by interlocking dovetails 65 and screw 66. A stop member 67 is attached to the spacer member 64 and is abutted by the side element 68 of the window frame. A metal spring clip 69 is screwed at its forward end 70 to the side element 69 of the window frame and the rear end of the clip 69 is formed as a U 71 which engages by snap action in the channel formed in the spacer member, with the free end thereof engaged under the projection lip of the upper wall of the spacer member.

With reference to FIG. 4, the body member 72 is, as shown in FIG. 3, locked to the inner and outer leaves of the wall by concrete 73 and the lower element 74 of the window frame is attached direct to the body member by means of spring clip 75 in a manner similar to that described with reference to spring clip 69 in FIG. 3. In both FIGS. 3 and 4, the spring clip has an intermediate portion which extends below the rear part of the window frame element. In FIG. 4, the front part of the lower frame element is formed as an external sill 76; the internal sill 77 is attached to the inner leaf 78 of the wall by screwing.

Typically, spring clips are spaced at 300 mm intervals along the body or spacer members, for attachment of the frame elements.

With reference to FIG. 5, the respective head 50, base 72 and side body members 62 with associated spacer 53, 64 and stop members 67 are shown with mitred corners, glued to form a rectangle for placement within a window aperture. As shown, the stop members terminate short of the respective head and bottom members to provide an allowance for the ventilator at the head and the sill at the bottom.

1. A cavity closer apparatus in strip form and suitable for use with ICF walls, the apparatus comprising a body member including a central portion for bridging a cavity between inner and outer wall leaves and respective front and rear projections for engaging exposed ends of the inner and outer wall leaves, in use, in which the body member incorporates means for lockable engagement of fixing cleats for a window or door frame.

2. Apparatus according to claim 1, in which the central portion of the body member includes a housing defining one or more voids containing insulation material.

3. Apparatus according to claim 1, in which the fixing cleats comprise clips formed from a flat strip of springy or resilient material adapted at the forward end portion for attachment to a door or window frame element and at the rearward end portion for lockable engagement with the body member, behind the frame element.

4. Apparatus according to claim 3, in which the fixing cleats are snap-engageable in a longitudinal channel formed in the body member.

5. Apparatus according to claim 1, further including a spacer member in strip form, the body and spacer members including means for mutual engagement at a desired position of the spacer member relative to the depth of the body member, the spacer member including means for lockable engagement of fixing cleats for the window or door frame.

6. Apparatus according to claim 5, in which the body and spacer members are formed with interlockable or interengageable projections/recesses.

7. Apparatus according to claim 1, further including an elongate stop member, attachable to the spacer member, to provide a forward abutment for the frame when placed in position from the interior of the building.

8. Apparatus according to claim 5, in which the means for interlockable engagement comprise dovetail-sectioned grooves and projections formed on respective parts of the apparatus.

9. A kit of parts comprising:
a plurality of body members, wherein each body member includes a central portion for bridging a cavity between inner and outer wall leaves and respective front and rear projections for engaging exposed ends of the inner and outer wall leaves in use in which the body member incorporates means for lockable engagement of fixing cleats for a window or door frame, and the central portion of the body member includes a housing defining one or more voids containing insulation material;
a plurality of spacer members, wherein each spacer member is in strip form, and includes means for mutual engagement at a desired position of the spacer member relative to the depth of the body member, the spacer member including means for lockable engagement of fixing cleats for the window or door frame;
a plurality of stop members, wherein each stop member includes an elongate stop member, attachable to the spacer member, to provide a forward abutment for the frame when placed in position from the interior of the building; and
a plurality of fixing cleats, wherein each fixing cleat includes clips formed from a flat strip of springy or resilient material adapted at a forward end portion for attachment to a door or window frame element and at a rearward end portion for lockable engagement with the body member, behind the frame element.

10. A method of closing a cavity especially in ICF walls, the method comprising applying to a head, jambs and a base of the cavity a body member, and optionally applying a spacer member and a stop member, the spacer member being in strip form, and including means for mutual engagement at a desired position of the spacer member relative to a depth of the body member, the spacer member further including means for lockable engagement of fixing cleats for the window or door frame, and the stop member including an elongate stop member, attachable to the spacer member, to provide a forward abutment for the frame when placed in position from the interior of the building; and attaching window or door frame elements thereto using the fixing cleats; each fixing cleat including clips formed from a flat strip of springy or resilient material attached at one end portion to the window or door frame elements and at an other end portion to the body or spacer members.

11. A method according to claim 10, in which said other end portion of the fixing cleats is attached to the body or spacer member by snap action engagement of the cleat in a channel formed in the body or spacer member.

12. Apparatus according to claim 2, in which the fixing cleats comprise clips formed from a flat strip of springy or resilient material adapted at the forward end portion for attachment to a door or window frame element and at the rearward end portion for lockable engagement with the body member, behind the frame element.

13. Apparatus according to claim 12, in which the fixing cleats are snap-engageable in a longitudinal channel formed in the body member.

14. Apparatus according to claim 3, further including a spacer member in strip form, the body and spacer members including means for mutual engagement at a desired position of the spacer member relative to the depth of the body member, the spacer member including means for lockable engagement of fixing cleats for the window or door frame.

15. Apparatus according to claim 14, in which the body and spacer members are formed with interlockable or interengageable projections/recesses.

16. Apparatus according to claim 2, further including an elongate stop member, attachable to the spacer member, to provide a forward abutment for the frame when placed in position from the interior of the building.

17. Apparatus according to claim 6, in which the means for interlockable engagement comprise dovetail-sectioned grooves and projections formed on respective parts of the apparatus.

18. Apparatus according to claim 4, further including a spacer member in strip form, the body and spacer members including means for mutual engagement at a desired position of the spacer member relative to the depth of the body member, the spacer member including means for lockable engagement of fixing cleats for the window or door frame.

19. Apparatus according to claim 18, in which the body and spacer members are formed with interlockable or interengageable projections/recesses.

20. Apparatus according to claim 3, further including an elongate stop member, attachable to the spacer member, to provide a forward abutment for the frame when placed in position from the interior of the building.
